(19) United States
(12) Patent Application Publication
(10) Pub. No.: US 2025/0291202 A1
(43) Pub. Date: Sep. 18, 2025

(54) RIMLESS GLASSES PRESS-TO-CHANGE LENS STRUCTURE

(71) Applicant: PROHERO GROUP CO., LTD., TAINAN CITY (TW)

(72) Inventor: PEN-WEI CHEN, TAINAN CITY (TW)

(21) Appl. No.: 18/739,858

(22) Filed: Jun. 11, 2024

(30) Foreign Application Priority Data
Mar. 15, 2024 (TW) 113202643

(51) Int. Cl. G02C 1/02; G02C 5/22

(52) U.S. Cl. CPC G02C 1/023; G02C 5/22; G02C 2200/20

(57) ABSTRACT

The invention relates to a rimless glasses press-to-change lens structure, which mainly forms a coupling portion on the outer side of the lens, and a guide groove is connected outward to a positioning hole arranged in the coupling portion. A front end of a receiving groove on an inner side of a coupling device is connected outwardly with an inserting slot for the coupling portion to be inserted. A pressing member is pivoted inside the receiving groove. A convex extension section is formed on the inner end face of the pressing member corresponding to the guide groove of the lens, and a latch part is formed on the outer end of the convex extension section. Therefore, during the assembly or replacement of the lens, there is no need for a corresponding tool kit, making it simpler and more convenient, and the assembly process can be completed more quickly and conveniently.

### BACKGROUND OF THE PRESENT INVENTION

### Field of Invention

The present invention relates to a rimless glasses press-to-change lens structure, in particular to an innovative design of rimless glasses press-to-change lens structure that not only does not need to prepare a corresponding tool kit in the process of assembling or replacing the lens, but also makes the assembly operation more quickly and can be assembled, and adds practical functional characteristics to its overall implementation.

### Description of Related Arts

It is noted that the common types of glasses can be divided into optical glasses, sunglasses, sports glasses and night vision protective glasses based on their functions, so that users can choose to wear them according to different times and different use needs, so that existing consumers usually own multiple pairs of glasses with different functions for easy replacement, such as: sports glasses need to have anti-UV function when the sun is strong during the day, and more light needs to pass through when the light is insufficient at night.

In terms of the basic structural design of the above-mentioned glasses, the lenses are assembled and fixed with the frame, so that the lenses are installed in the lens assembly holes of the frame, and the screwed elements are screwed in the screw holes corresponding to the lens assembly holes of the frame, so as to screw and fix the lens assembly holes, and the lenses are firmly clamped in the lens assembly holes of the frame, and then the temples are pivoted on both sides of the frame to complete the assembly and combination of the glasses.

However, although the lenses of the above-mentioned glasses can achieve the desired effect of firmly clamping the lenses in the lens assembly holes of the frame through the screwing of screw elements, it was also found in their actual operation and use that during the assembly or disassembly process of the lens and the lens assembly hole, it is necessary to use a screw tool to screw or loosen the screw elements, which not only causes great inconvenience in the assembly or disassembly of the lens, but also causes the inability to assemble or disassemble the lens if there is no suitable screwing tool at hand. As a result, there is still room for improvement in the overall structural design.

In view of this, the inventor has relied on many years of rich design, development and actual production experience in this related industry, researched and improved the conventional structure and deficiencies, and provided a rimless glasses press-to-change lens structure in order to achieve better practical value.

### SUMMARY OF THE PRESENT INVENTION

The main purpose of the present invention is to provide a rimless glasses press-to-change lens structure, which can be used in the process of assembling or replacing the lens, not only does not need to prepare the corresponding tool kit, can be simpler and more convenient, and also makes the assembly operation can be completed more quickly, and the practical function characteristics are added to its overall implementation and use.

The main purpose and effect of the rimless glasses press-to-change lens structure of the present invention are achieved by the following specific technical means:
it mainly includes a lens, a temple, and a coupling device, wherein
the lens has a coupling portion formed on an outer side thereof, wherein the coupling portion has a positioning hole arranged thereof, and a guide groove provided in the positioning hole and connected with the outside of the coupling part,
wherein the temple has a pivot section arranged at a front end thereof,
wherein the coupling device is arranged between the lens and the temple, wherein the coupling device has a receiving groove formed concavely on an inner side thereof, wherein the receiving groove includes a pivot unit provided therein that corresponding and matching with the pivot section of the temple, and an inserting slot connected to the outside of the coupling device at a front end of the receiving groove for the coupling portion of the lens to be plugged and coupled, wherein the coupling device has a pressing member arranged in the receiving groove, wherein the pressing member has a pivot portion arranged at a rear end thereof corresponding to the pivot unit, so that the pivot portion and the pivot section of the temple are pivotally combined with the pivot unit, and an outer edge of the pivot portion is supported against an inner end surface of the receiving groove, so that a pressing activity space is formed between the pressing member and the inner end surface of the receiving groove through the abutment support of the outer edge of the pivot portion, wherein the pressing member has a convex extension section protruding from an inner end face thereof corresponding to the guide groove of the lens, a latch part formed at an outer end of the convex extension section.

In a preferred embodiment of the rimless glasses press-to-change lens structure according to the present invention, the lens has an against convex portion convexly formed on the outer side thereof corresponding to the lower portion of the coupling portion.

In a preferred embodiment of the rimless glasses press-to-change lens structure according to the present invention, the pressing member has a guide slope formed on an inner edge of the latch part.

### BRIEF DESCRIPTION OF THE DRAWINGS

FIG. 1 is an exploded view of the present invention.

FIG. 2 is an exploded view of the present invention from another angle.

FIG. 3 is a partially exploded view of the present invention.

FIG. 4 is a top sectional partially exploded view of the present invention.

FIG. 5 is an assembly perspective view of the present invention.

FIG. 6 is a top sectional assembly view of the present invention.

FIG. 7 is an action view of the lens disassembly operation of the present invention.

### DETAILED DESCRIPTION OF THE PREFERRED EMBODIMENT

In order to have a more complete and clear disclosure of the technical content, the purpose of the invention and the effects achieved by the present invention, it is explained in detail below, and refer to the disclosed drawings and drawing numbers.

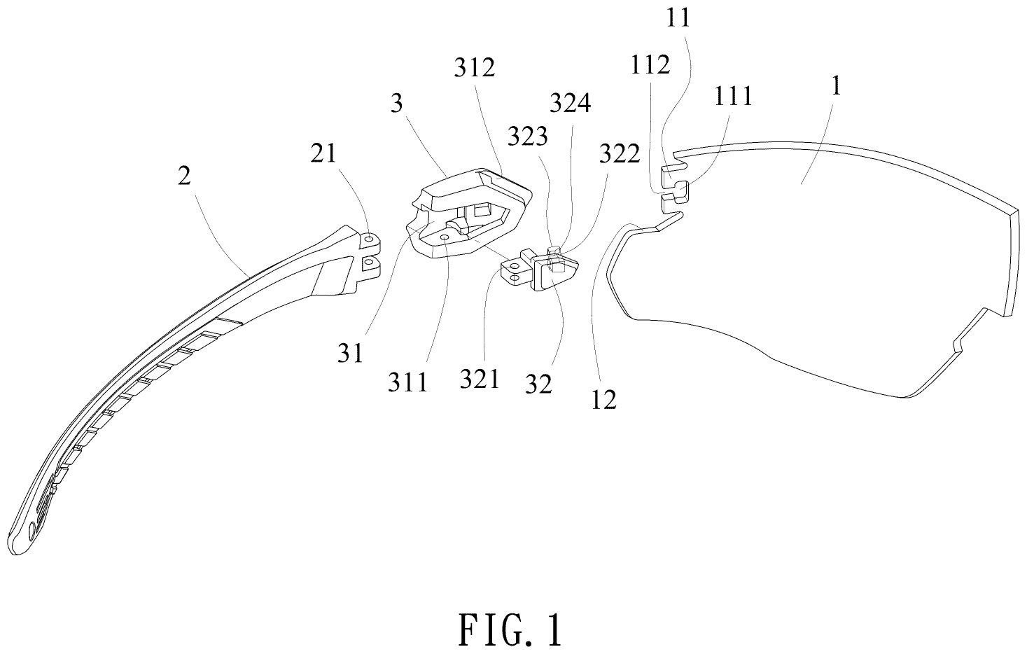

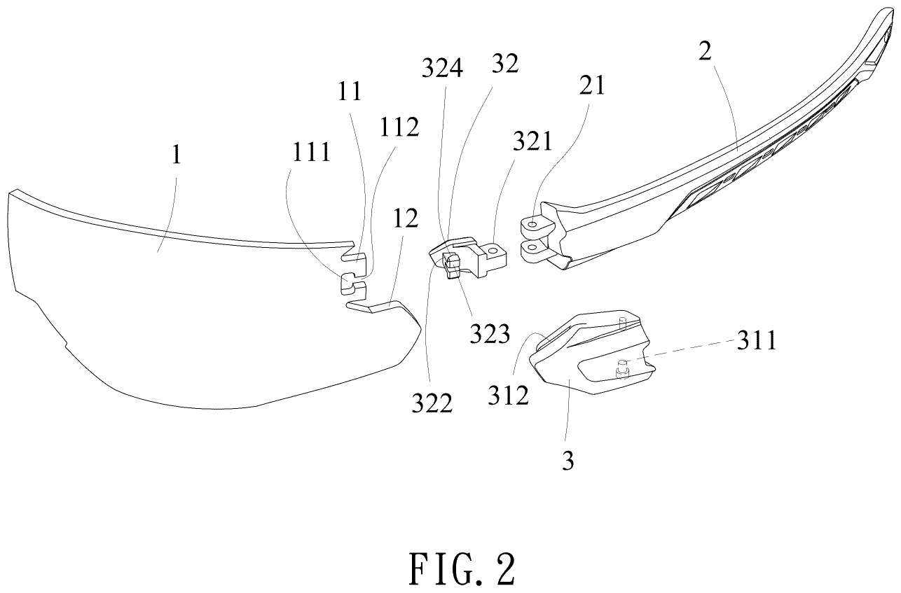

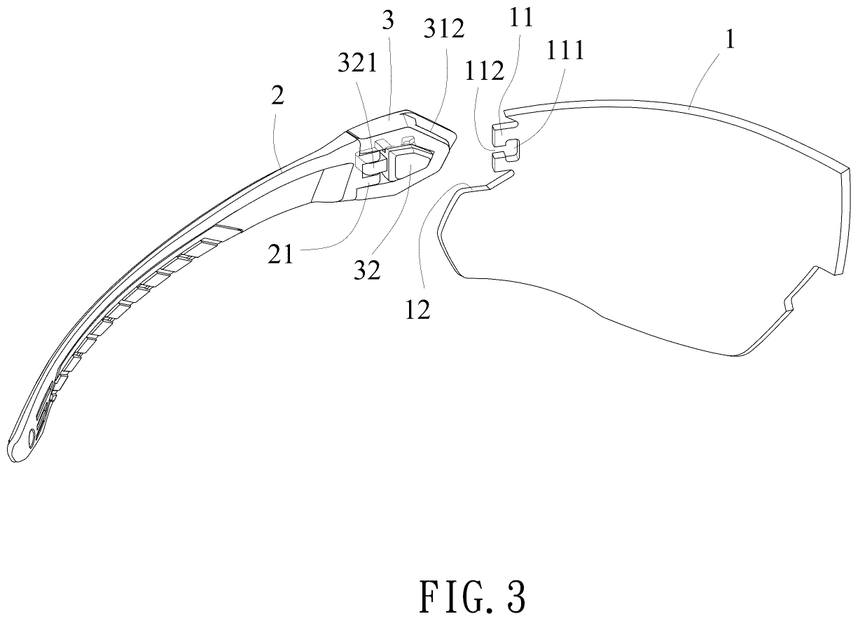

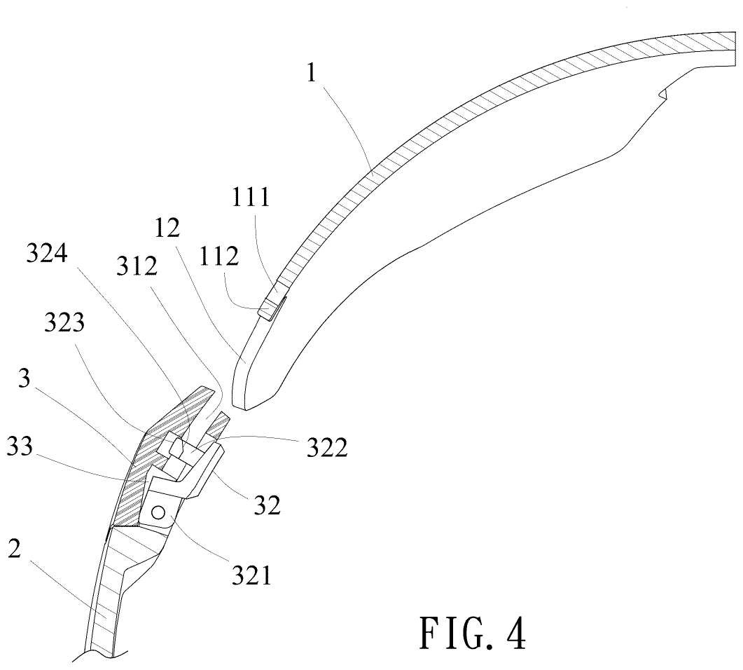

First, refer to FIG. 1, which is an exploded view of the present invention; FIG. 2, which is an exploded view of the present invention from another angle; FIG. 3, which is a partially exploded view of the present invention; and FIG. 4, which is a top sectional partially exploded view of the present invention. The present invention mainly includes a lens (1), a temple (2) and a coupling device (3), wherein
the lens (1) has a coupling portion (11) formed on an outer side thereof, wherein the coupling portion (11) has a positioning hole (111) arranged thereof, and a guide groove (112) provided in the positioning hole (111) and connected with the outside of the coupling part (11), wherein the lens (1) has an against convex portion (12) convexly formed on the outer side thereof corresponding to the lower portion of the coupling portion (11),
wherein the temple (2) has a pivot section (21) arranged at a front end thereof,
wherein the coupling device (3) is arranged between the lens (1) and the temple (2), wherein the coupling device (3) has a receiving groove (31) formed concavely on an inner side thereof, wherein the receiving groove (31) includes a pivot unit (311) provided therein that corresponding and matching with the pivot section (21) of the temple (2), and an inserting slot (312) connected to the outside of the coupling device (3) at the front end of the receiving groove (31) for the coupling portion (11) of the lens (1) to be plugged and coupled, wherein the coupling device (3) has a pressing member (32) arranged in the receiving groove (31), wherein the pressing member (32) has a pivot portion (321) arranged at the rear end thereof corresponding to the pivot unit (311), so that the pivot portion (321) and the pivot section (21) of the temple (2) are pivotally combined with the pivot unit (311), and the outer edge of the pivot portion (321) is supported against the inner end surface of the receiving groove (31), so that a pressing activity space (33) is formed between the pressing member (32) and the inner end surface of the receiving groove (31) through the abutment support of the outer edge of the pivot portion (321), wherein the pressing member (32) has a convex extension section (322) protruding from an inner end face thereof corresponding to the guide groove (112) of the lens (1), a latch part (323) formed at an outer end of the convex extension section (322), a guide slope (324) formed on the inner edge of the latch part (323).

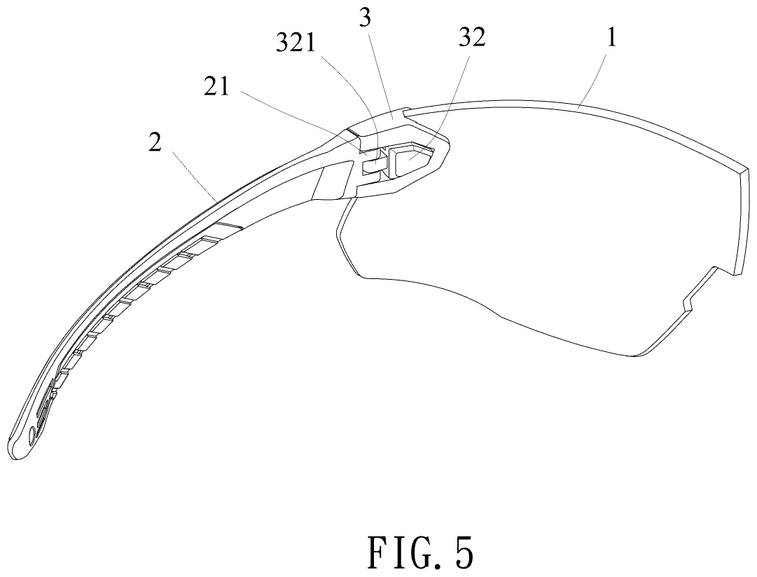

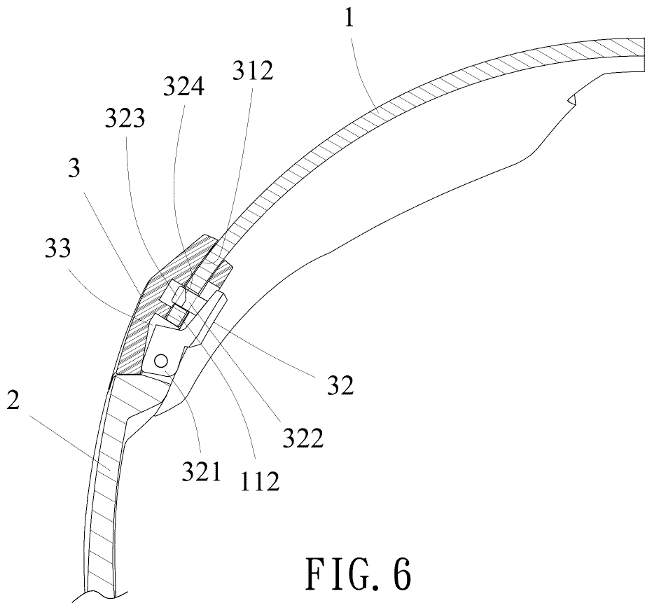

In this way, referring to the assembly perspective of the present invention in FIG. 5 and the top sectional assembly view of the present invention in FIG. 6, when the invention is assembled and combined, the coupling portion (11) of the lens (1) is inserted into the inserting slot (312) of the coupling device (3), so that the outer side of the coupling portion (11) pushes the latch part (323) of the pressing member (32), and since the guide slope (324) is formed on the inner edge of the latch portion (323), the outer side of the coupling portion (11) can more easily push the latch part (323) toward the receiving groove (31) along the guide slope (324), so that the latch part (323) drive the convex extension section (322) together with the pressing member (32) to move into the receiving groove (31). At this time, the convex extension section (322) can pass through the guide groove (112) of the coupling portion (11) and enter the positioning hole (111). At this time, the latch part (323) loses the pushing force from the outer side of the coupling portion (11), and is supported by the force from the outer edge of the pivot portion (321) to the inner end surface of the receiving groove (31), and will return to an original position. The latch part (323) is blocked by the guide groove (112) and is positioned in the positioning hole (111), so that the lens (1) is firmly combined with the coupling device (3) and does not fall off, at the same time, the lower edge of the coupling device (3) is supported by the against convex portion (12) protruding below the lens (1), and will not rotate and shift arbitrarily.

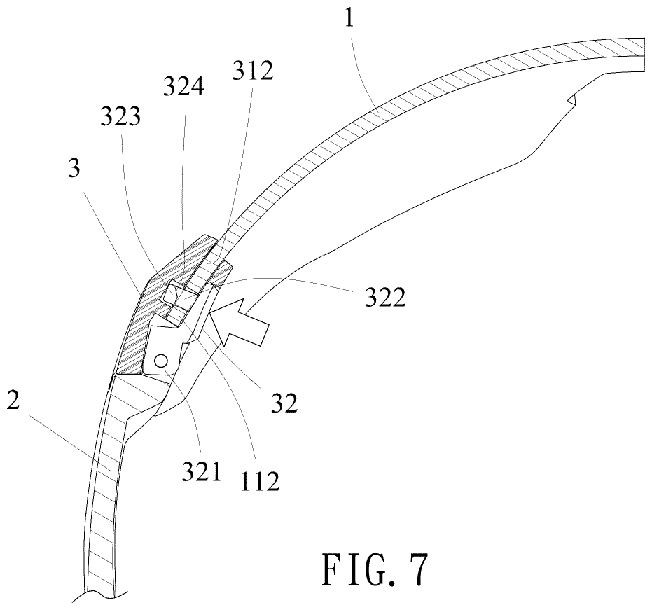

Referring to FIG. 7, which is an action view of the lens disassembly operation of the present invention. When disassembling or replacing the lens (1), simply press the pressing member (32) inward, allowing pressing member (32) moves toward the inside of the receiving groove (31) within the range of the pressing activity space (33). This causes the latch part (323) to move away from the guide groove (112), while the convex extension section (322) corresponds to the guide groove (112), allowing the lens (1) to be pulled out from the inserting slot (312). This separates the lens (1) from the coupling device (3), thereby achieving the purpose of disassembling and replacing the lens (1).

From the above and the description of the use of the present invention, it can be seen that compared with the conventional technical means, the present invention mainly achieves easier and more convenient assembly or replacement of the lens without the need for specific tool sets, resulting in faster completion of assembly and enhanced practical functionality.

The foregoing embodiments or drawings do not limit the structural form of the present invention. Any appropriate changes or modifications made by those with ordinary knowledge in the technical field shall be regarded as not departing from the patent scope of the present invention.

What is claimed is:

1. A rimless glasses press-to-change lens structure, comprising a lens, a temple, and a coupling device, wherein
the lens has a coupling portion formed on an outer side thereof, wherein the coupling portion has a positioning hole arranged thereof, and a guide groove provided in the positioning hole and connected with the outside of the coupling part,
wherein the temple has a pivot section arranged at a front end thereof,
wherein the coupling device is arranged between the lens and the temple, wherein the coupling device has a receiving groove formed concavely on an inner side thereof, wherein the receiving groove includes a pivot unit provided therein that corresponding and matching with the pivot section of the temple, and an inserting slot connected to the outside of the coupling device at a front end of the receiving groove for the coupling portion of the lens to be plugged and coupled, wherein the coupling device has a pressing member arranged in the receiving groove, wherein the pressing member has a pivot portion arranged at a rear end thereof corresponding to the pivot unit, so that the pivot portion and the pivot section of the temple are pivotally combined with the pivot unit, and an outer edge of the pivot portion is supported against an inner end surface of the receiving groove, so that a pressing activity space is formed between the pressing member and the inner end surface of the receiving groove through the abutment support of the outer edge of the pivot portion, wherein the pressing member has a convex extension section protruding from an inner end face thereof corresponding to the guide groove of the lens, a latch part formed at an outer end of the convex extension section.

2. The rimless glasses press-to-change lens structure as claimed in claim 1, wherein the lens has an against convex portion convexly formed on the outer side thereof corresponding to the lower portion of the coupling portion.

3. The rimless glasses press-to-change lens structure as claimed in claim 1, wherein the pressing member has a guide slope formed on an inner edge of the latch part.
